(19) United States
(12) Patent Application Publication
(10) Pub. No.: US 2011/0104530 A1
(43) Pub. Date: May 5, 2011

(54) METHOD AND DEVICE PROVIDING THE TEMPERATURE REGULATION OF A RECHARGEABLE ELECTRICAL ENERGY STORAGE BATTERY

(75) Inventors: Christian Muller, Strasbourg (FR); Jean-Claude Heitzler, Horbourg-Wihr (FR); Alain-Francois Douarre, Gif sur Yvette (FR)

(73) Assignees: DOW KOKAM FRANCE S.A.S., Massy (FR); SOCIETE DE VEHICULES ELECTRIQUES S.A.S., Paris (FR)

(21) Appl. No.: 13/002,360

(22) PCT Filed: Jul. 2, 2009
(86) PCT No.: PCT/FR2009/000825

§ 371 Date: Jan. 4, 2011

(30) Foreign Application Priority Data
Jul. 7, 2008 (FR) 08/03857

(51) Int. Cl. H01M 10/50

(52) U.S. Cl. 429/62

(57) ABSTRACT

A thermal control device for at least one rechargeable electrical energy storage battery, in particular for a battery of a vehicle with electric or hybrid drive and comprising at least one electrochemical component. The device comprises at least one enclosure in which the electrochemical component of the battery is housed, at least one magnetocaloric heat pump associated with the enclosure, at least one heat transfer fluid circulating circuit coupled between the battery and the heat pump and at least one heat exchanging component that is open to the exterior environment and connected to the heat transfer fluid circulating circuit to exchange calories with the exterior environment.

This application is a National Stage completion of PCT/FR2009/000825 filed Jul. 2, 2009, which claims priority from French patent application serial no. 08/03857 filed Jul. 7, 2008.

### FIELD OF THE INVENTION

The present invention concerns a thermal control process, both autonomous and permanent, for at least one rechargeable electrical energy storage battery, in particular for a battery of a vehicle with electric or hybrid traction, comprising at least one electrochemical component.

The present invention also concerns a thermal control device, both autonomous and permanent, for at least one rechargeable electrical energy storage battery, in particular for a battery of a vehicle with electric or hybrid traction, comprising at least one electrochemical component.

### BACKGROUND OF THE INVENTION

Rechargeable electric batteries constitute the main critical component of vehicles with electric or hybrid traction. The latest generation of electrochemical batteries, particular lithium ones, have achieved a level of performance sufficient for market positioning. However, rigorous internal thermal control of the batteries is crucial to guarantee the durability of this costly and relatively fragile component. Moreover, current embodiments do not yet offer the stability of service (normal operation guaranteed whatever the ambient temperature), or even the availability of the battery under certain operating conditions, which the users of fossil fuel vehicles have become accustomed to, namely a mileage autonomy that is not temperature-dependent.

Indeed, the temperature variations suffered by the electrochemical element of these new high energy or power density batteries strongly affect, depending on their environmental and operating conditions, cumulatively their health and longevity, and instantaneously their level of performance. It is therefore generally accepted that these batteries require an active thermal control system from the moment they reach a certain critical size or if they are placed in a stressful thermal environment.

Current solutions mainly come from traditional thermal control devices with air or heat transfer fluid, but with the disadvantage of being big energy consumers, cumbersome and not very efficient. Another disadvantage resulting from the previous one is that these control devices can only be relied upon in a limited way since they must draw their energy from the battery itself. That is the case when the battery is in autonomy mode, i.e. when it is not being recharged.

For electric or hybrid vehicles in particular, the thermal control system is typically activated only when the vehicle is running or charging. On the road, the thermal control device generally limits itself to taking advantage of the thermal resources freely available when its temperature balance is favorable (for example direct exchange with the ambient air). Consequently, the performance of the battery is not optimised and varies especially with the season. Moreover, since the control device is deactivated when the vehicle is stopped, after an extensive period parked under adverse conditions, the performance of the battery can deteriorate to the point where the vehicle becomes totally immobilized.

These defects are hard to accept for users who have been accustomed to high levels of performance and remarkable reliability, even with bottom-of-the-range vehicles, as well as unfailing service reliability.

Furthermore, there are cooling devices for the heat engines of vehicles that use a magnetocaloric material heat pump within their cooling system, which recovers the thermal energy produced by the engine and reuses it in the vehicle's passenger compartment—in particular, see publications US2005/0047284 and JP2005/055060. However, these cooling devices depend on the engine's operation and cannot be activated independently. Hence, they cannot be assigned to the cooling of a battery as such.

However, it seems essential that solutions be brought forward to improve this situation and resolve the shortcomings of existing thermal control devices.

### SUMMARY OF THE INVENTION

The aim of this invention consists in overcoming the disadvantages mentioned above by bringing forward a thermal control with high energy efficiency and low consumption of electrical energy, which is environmentally friendly and capable of providing accurate, autonomous and permanent thermal control of the battery, by mobilizing very little of its stored electrical energy to feed the thermal control so as to maximize the capacity of the battery available for the useful functions of the system supplied, especially the driveability and autonomy of electric vehicles.

This aim is achieved by the process according to the invention as defined in preamble, characterized in that at least one enclosure is used in which the electrochemical component of the battery is housed, at least one magnetocaloric heat pump associated with the enclosure, and at least one heat exchanging component open to the outside environment and in that calories are exchanged between the electrochemical component of the battery and the outside environment by means of a heat transfer fluid circulating circuit coupled between the battery, the heat exchanger and the heat pump.

The process according to the invention overcomes the disadvantages previously mentioned in that the thermal power restored, used to allow the thermal control of the battery, draws little on its internal resources, thanks to the exceptional energy efficiency (performance coefficient comprised between 4 and 10) of the magnetocaloric heat pump which is based on a quantum property of matter: a varying spin orientation of the external electrons of the atoms that make up the magnetocaloric alloy(s) and not on a phase change of a cooling gas caused by a high energy consuming mechanical action of compression and expansion. Hence the thermal control device can be used regularly, even when the vehicle is running in autonomy mode on its battery, thus allowing the battery to operate permanently under favorable conditions.

According to an advantageous embodiment, several magnetocaloric heat pumps are used, each of these pumps operating over a set temperature range, and at least one of the pumps is connected to the battery and the heat exchanging component open to the outside environment according to the inside and/or outside temperature range of the electrochemical component of the battery.

The advantage of this arrangement is that in any event, the thermal control of the battery is covered by one or more magnetocaloric heat pumps optimized for the current temperature range. This way of proceeding is beneficial having a much greater energy efficiency than a single heat pump, which would have to be sized for a wide area of the temperature rang, despite never operating near the extreme temperatures of this temperature range.

Advantageously, in an embodiment adapted to the thermal control of a battery or group of batteries exposed to large temperature variations between summer and winter, two magnetocaloric pumps are used, each arranged to operate in a temperature range of about 50K: one of the pumps between a minimum temperature of the exchanger open to the outside environment of about −35° C. and an inside temperature of about +20° C., and the other of the pumps between a maximum temperature of the exchanger of about +70° C. and an inside temperature of about +20° C.

Advantageously, the several heat pumps pool common functions so as to constitute a single apparatus. Indeed, since the only part that differentiates them is the active regenerator with the magnetocaloric materials adapted to the temperature ranges, the other functions such as the casing, the magnetic switching system, the hydraulic switching system, and the drive and pumping systems can be put in common in an adapted mechanical design, by means of a hydraulic or mechanical switching device of the regenerators, so that the heat transfer fluid only circulates in the regenerator(s) adapted to the current operating conditions.

This aim is also achieved by the device according to the invention, characterized in that it comprises at least one enclosure in which the electrochemical component of the battery is housed, at least one magnetocaloric heat pump associated with the enclosure, at least one heat transfer fluid circulating circuit coupled between the battery and the heat pump and at least one heat exchanging component open to the outside environment and connected to the heat transfer fluid circulating circuit to exchange calories with the outside environment.

According to a preferred embodiment, the device comprises several magnetocaloric heat pumps, each of these pumps operating over a set temperature range, and at least one of the pumps being connected to the battery and the heat exchanging component open to the outside environment according to the inside and/or outside temperature range of the electrochemical component of the battery.

In a specific case adapted to the thermal control of a battery or group of batteries exposed to large climatic variations between summer and winter, the device advantageously comprises two magnetocaloric pumps, arranged to typically operate in a temperature gradient of about 50K, between a minimum temperature of the exchanger open to the outside environment of about −30° C. and an inside temperature of about +20° C. for one of the pumps, and between a maximum temperature of the exchanger of about +70° C. and an inside temperature of about +20° C. for the other of the pumps. The number of magnetocaloric heat pumps and the temperature gradient shall be adjustable at the time of the design according to the climatic conditions to which the batteries of electrochemical elements will be exposed.

Preferably, the two or more pumps are in fact combined into a single apparatus comprising two or more magnetocaloric regenerators, each dedicated to a specific temperature range, as well as a hydraulic or mechanical switching device for the regenerators, so that the heat transfer fluid only circulates in the regenerator(s) adapted to the current operating conditions.

### BRIEF DESCRIPTION OF THE DRAWING

The present invention and its advantages will be better revealed in the following description which describes an embodiment, given as a non limiting example in reference to the drawing in appendix, in which:

the sole FIGURE is a schematic view of an advantageous embodiment of the device of the invention.

### DETAILED DESCRIPTION OF THE PREFERRED EMBODIMENTS

The method of the invention is based on the magnetocaloric heat pump technology, the main advantages of which are its great energy efficiency, its low electric energy consumption, an environmentally and atmospherically friendly mode of operation, and the absence of gas.

The process consists of performing an integrated thermal control, called thermostatting, of the battery, with a high energy efficiency and low consumption, environmentally friendly, in order to achieve an accurate, autonomous and continuous or permanent thermal control of the battery or group of batteries, whether the battery or group of batteries is active or passive. The process has the double function of balancing the heat exchanges with the outside environment at very low energy cost, and of dissipating the internal heat inputs of the battery in service, when the vehicle is used and when the battery is recharging. This balancing of heat exchanges and evacuation of excess internal heat inputs are preferably spread out over a cycle of 24 hrs by taking advantage of the battery's thermal inertia.

The process does not only apply to batteries or groups of batteries intended for the traction of electric or hybrid vehicles, but also to any transportable or stationary battery of a certain size and power or energy density, the operating conditions of which justify an active thermal control, both permanent and efficient. One of these conditions is that the battery cannot thermally exchange, in the phases where it needs to, with external heat sources whose temperatures are compatible with a direct heat transfer.

In other words, the process according to the present invention allows the thermostatting of at least one battery, whatever the environment in which the battery is integrated. This temperature control of the battery is carried out permanently and autonomously. As a result, when the battery is a vehicle battery for example, this control is performed even when the engine of the vehicle is stopped, so as to extend the battery's service life and optimize its performances.

Similarly, the thermostatting of a battery via the process according to the invention shall be performed when this battery is charging as well as when it is being stored, for example. This process thus allows a battery-pack to be made which comprises an integrated, continuous and autonomous control of the battery(-ies).

Evidently, the process according to the invention is not limited to the control of the temperature of a vehicle battery. It can be used for any type of battery(-ies) (domestic or industrial, for example) whose performance and durability, in particular, can be increased via the implementation of the process that allows the temperature to be controlled constantly and advantageously in terms of energy consumption.

The active cooling with regeneration through magnetocaloric effect used in the magnetocaloric heat pump is based on the capacity of components called “magnetocaloric materials” to heat up and cool down when they are placed in or removed from a magnetic field and, more generally, when they are subjected to a variation in magnetic field. This effect is known in itself, but it is mainly used to for cooling in air-conditioning or refrigerating units, because it allows a result to be achieved in a non-polluting manner, which is usually achieved using refrigerating equipment with compressors that use polluting greenhouse gases.

Regarding magnetocaloric heat pumps, and unlike traditional refrigerating machines and heat pumps, which use cooling gases with a significant greenhouse effect or which are harmful for the ozone layer (CFC, HFC), they use heat transfer fluids which are harmless to the environment, especially brine or water with added glycol. Fluid-related problems therefore no longer arise. Indeed, the functions of transport of calories and temperature variation are dissociated, unlike traditional machines where they are carried out by the refrigerant.

The exploitation of magnetocaloric phenomena is based on the simultaneous interaction of magnetic fields and heat transfers within a volume of magnetocaloric material. The cohabitation of these contiguous phenomena is faced with contradictory requirements in terms of fluid flow, magnetic permeability, thermal conductivity, corrosion resistance, viscous friction and electromagnetic pressure.

Recent scientific advances on these apparatuses concern heat exchanges with a high exchange coefficient (h>40000 W/m²K) for high frequencies (50 to 100 Hz) between a solid which is the magnetocaloric material and a heat transfer fluid which is, for example, brine or water with additives so as to achieve the objectives of low energy consumption and advanced mechanical integration in a group of batteries.

Regarding the batteries, many theoretical and experimental results on high energy and power density batteries, the most advanced of which are currently the Lithium-polymer type electrochemistries, establish the relationship between the thermal conditions of the electrochemical components of the batteries and their performances in charging and discharging, as well as their aging. It has been noted that temperature is exponentially related to the calendar aging of the electrochemical components of batteries, which results in an increase of its internal resistance, and a decrease of its capacity and dischargeable power. It is the cumulated time of exposure to irregular and high temperatures, in particular in a charged state, which contributes to aging, whether the battery is active or passive. In charge and discharge, internal heat losses contribute to a temperature rise in the battery, which is all the more significant as the charge or discharge power is high. From a certain mass internal temperature of the battery, there is risk of local temperature rise inside the electrochemical components of the batteries when high power demands occur, which can lead to a thermal runaway. Various increasingly exothermic chemical reactions may occur successively as the temperature rises, until the destruction of the battery if nothing is designed to prevent the phenomenon. In practice, when the internal temperature of the battery reaches a potentially risky level, the battery's control system limits the recoverable power, until the immobilization of the vehicle if the temperature continues to rise. The dischargeable capacity is notably dependent on the internal temperature of the battery, so that the autonomy of the vehicle may markedly vary between winter and summer if the battery is left to thermally balance with the outside environment.

At low temperature, the allowed maximum and continuous recharge powers decrease strongly, until the inability to recharge below a temperature threshold which depends on the electrochemistries, though they are often above the minimum winter temperatures of continental and northern Europe.

At low temperature, the dischargeable energy and recoverable power also decrease markedly, and consequently the performance of the vehicle and its autonomy, and can lead to the inability to start at very low temperatures, which also vary according to the electrochemistries.

The expected advantages of the process according to the invention are:
substantial gains in the durability of the battery,
a service availability equivalent to that of current vehicles with thermal engines at nominal service level, under any operating and storage conditions of the vehicle, as long as the battery is not discharged,
an optimized use of the battery which guarantees the stability of performances, maximizes the dischargeable energy and ensures the reliability of the indication of remaining autonomy,
significant gains in electric energy consumption at the outlet.

The thermal control or thermostatting device 10, according to the invention, integrated, with high energy efficiency and low consumption based on the technology of magnetic cooling with no cooling gas, constitutes an alternative that is both technically and economically viable compared to ventilation or compression systems with cooling gases used in applications for the thermostatting of the rechargeable battery-packs of hybrid and electric vehicles at non limiting operating temperatures ranging from −30° C. to +60° C.

The thermal control device 10 operates autonomously and permanently. The storage battery or batteries are permanently temperature controlled, which allows their service life and performances to be increased. In the case of vehicle batteries, this control is permanent and is performed even after the engine has been stopped, since the mechanical energy of the latter is not used. The thermal control device 10 can be regarded as a battery-pack that comprises an integrated control of the battery(-ies).

Evidently, the control device according to the invention is not limited to the control of the temperature of a vehicle battery. It may comprise any type of battery(-ies) whose performances and durability one wishes to increase by implementing the process according to the invention.

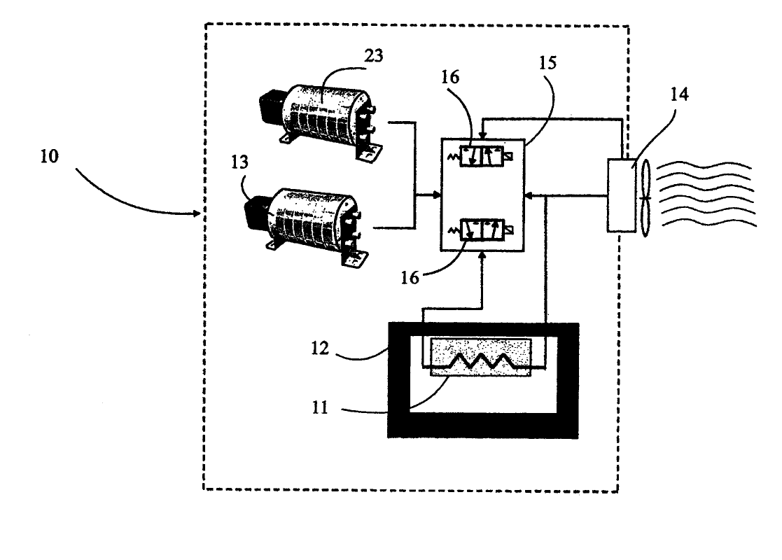

The device 10 of FIG. 1 comprises a group of rechargeable batteries 11 housed in a receptacle 12, at least one magnetocaloric heat pump 13, but in the example illustrated two magnetocaloric heat pumps 13 and 23, one heat exchanger 14 and one heat transfer fluid circulating circuit 15 that connects these various components. One or more separating valves 16 are mounted on the heat transfer fluid circulating circuit 15 to operate the magnetocaloric heat pump 13 or the magnetocaloric heat pump 23 according to the information given by a heat sensor placed inside the battery-pack. The magnetocaloric heat pump 13, 23 is only fed by the battery-pack in which it is integrated.

In practice, each magnetocaloric heat pump 13, 23 is adapted to a temperature range in which the magnetocaloric materials used are operational. Hence one of the pumps, for example pump 13, is arranged to operate in a temperature gradient of about 50 K, for example between a minimum exchanger temperature of about −30° C. and an inside temperature of about +20° C., which correspond to winter conditions in cold countries. The other pump, for example pump 23, is arranged to operate between a maximum exchanger temperature of about +70° C. and an inside temperature of about +20° C., which correspond to summer conditions in hot countries.

In terms of operation, the device 10 of the invention is designed to significantly push back the compromises tolerated with the first generation of vehicles, in terms of service availability and stability of the performances. It is apt to considerably reduce the issues of premature aging of the battery and additionally allows the optimum performance and autonomy of the vehicle to be permanently available. Moreover, this device 10 draws less energy from the battery, and frees up autonomy, while consuming less electric energy at the outlet when recharging the batteries.

1-8. (canceled)

9. A thermal control method, both autonomous and permanent, for at least one rechargeable electric energy storage battery, for a vehicle with electric traction, comprising at least one electrochemical component, the method comprising the steps of:
housing the electrochemical component of the battery (11) in at least one enclosure (12) with at least one magnetocaloric heat pump (13, 23) being associated with the enclosure, and at least one heat exchanging component (14) being open to an environment outside the at least one enclosure (12); and
exchanging calories between the electrochemical component of the battery (11) and the environment outside the at least one enclosure (12) with a heat transfer fluid circulating circuit (15) being coupled between the battery (11), the heat pump (13, 23) and the heat exchanging component (14).

10. The method according to claim 9, further comprising the steps of utilizing several magnetocaloric heat pumps (13, 23) and operating each of the magnetocaloric heat pumps (13, 23) over a set temperature range, and connecting at least one of the magnetocaloric heat pumps (13, 23) to the battery and the heat exchanging component being open to the environment outside the at least one enclosure (12), according to at least one of an inside and an outside temperature range of the electrochemical component of the battery.

11. The method according to claim 10, further comprising the step of utilizing two magnetocaloric heat pumps (13, 23) in thermally controlling the battery or a group of batteries exposed to large climatic variations between winter and summer, the two magnetocaloric heat pumps are appreciably operatable in a temperature gradient of about 50 K, a first of two magnetocaloric heat pumps operating between a minimum temperature of the heat exchanging component of about −30° C. and an inside temperature of about +20° C., and a second of two magnetocaloric heat pumps operating between a maximum temperature of the heat exchanging component of about +70° C. and an inside temperature of about +20° C.

12. The method according to claim 10, further comprising the steps of integrating the magnetocaloric heat pumps (13, 23) into a single device (10) that pools at least some undifferentiated functions of the magnetocaloric heat pumps and utilizing at least two magnetocaloric regenerators, each being adapted to a specific temperature range, and utilizing one of a hydraulic and a mechanical switching device (16) for the two magnetocaloric regenerators to circulate heat transfer fluid only in the magnetocaloric regenerator adapted to current operating conditions

13. A thermal control device (10) for at least one rechargeable electrical energy storage battery, for a vehicle with either electric or hybrid traction, comprising at least one electrochemical component, the thermal control device (10) comprising:
at least one enclosure (12) in which the electrochemical component of the battery (11) is housed,
at least one magnetocaloric heat pump (13, 23) being associated with the enclosure,
at least one heat transfer fluid circulating circuit (15) being coupled between the battery and the heat pump and at least one heat exchanging component (14) being open to an environment outside the enclosure and connected to the heat transfer fluid circulating circuit for exchanging calories with the environment outside the enclosure.

14. The device according to claim 13, further comprising several magnetocaloric heat pumps (13, 23), each of the several magnetocaloric heat pumps (13, 23) operate over a set temperature range according to at least one of an inside and an outside temperature range of the electrochemical component of the battery, and at least one of the several magnetocaloric heat pumps (13, 23) is connected to the battery and the heat exchanging component being open to the environment outside the enclosure.

15. The device according to claim 14, wherein the device is adapted to thermally control either the battery or a group of batteries that are exposed to large climatic variations between winter and summer, the device comprising two magnetocaloric heat pumps (13, 23) that are arranged appreciably operate in a temperature gradient of about 50 K, a first of the two magnetocaloric heat pumps operates between a minimum temperature of the heat exchanging component that is open to the environment outside the enclosure of about −30° C. and an inside temperature of about +20° C., and a second of the two magnetocaloric heat pumps operates between a maximum temperature of the heat exchanging component that is open to the environment outside the enclosure of about +70° C. and an inside temperature of about +20° C.

16. The device according to claim 14, wherein the several magnetocaloric heat pumps (13, 23) are integrated into a single apparatus that pools at least some of their undifferentiated functions, at least two magnetocaloric regenerators, each being adapted to a specific temperature range, and either a hydraulic or a mechanical switching device (16) for the regenerators so that heat transfer fluid only circulates in the regenerator adapted to current operating conditions.
